(19) United States
(12) Patent Application Publication
(10) Pub. No.: US 2026/0299260 A1
(43) Pub. Date: Oct. 1, 2026

(54) OPTICAL SYSTEM AND IMAGING APPARATUS INCLUDING OPTICAL SYSTEM

(71) Applicant: CANON KABUSHIKI KAISHA, Tokyo (JP)

(72) Inventor: SHINICHIRO SAITO, Tochigi (JP)

(21) Appl. No.: 19/575,444

(22) Filed: Mar. 23, 2026

(30) Foreign Application Priority Data
Mar. 26, 2025 (JP) 2025-051861

(51) Int. Cl. G02B 13/00; G02B 3/00; G02B 7/02; G02B 27/64; H04N 23/55

(52) U.S. Cl. CPC G02B 13/0045; G02B 7/025; G02B 13/006; G02B 27/646; H04N 23/55; G02B 2003/0093

(57) ABSTRACT

An optical system includes a front group including one or more lens groups, an aperture stop, and a rear group including one or more lens groups, wherein the rear group includes a focus lens group A, wherein the front group includes a first lens group having a positive refractive power and a focus lens group B disposed in this order from the object side to the image side, wherein, during focusing from infinity to the close distance, the first lens group is stationary relative to an image plane, and the focus lens group A and the focus lens group B move in an optical axis direction relative to the image plane, wherein the focus lens group A moves in a direction including a component in a direction perpendicular to an optical axis to correct an image shake, and wherein a predetermined conditional inequality is satisfied.

### BACKGROUND

### Field of the Technology

The present disclosure relates to an optical system and an imaging apparatus including an optical system, and in particular, relates to an optical system suitable for optical apparatuses such as still cameras, video cameras, and monitoring cameras.

### Description of the Related Art

In recent years, it has been known that an optical system used for an imaging apparatus has an image stabilization function implemented by moving a part of lens groups constituting the optical system to correct an image shake, as in International Publication No. WO 2022/097401.

### SUMMARY

According to an aspect of the present disclosure, an optical system includes a front group including one or more lens groups, an aperture stop, and a rear group including one or more lens groups, the front group, the aperture stop, and the rear group being disposed in this order from an object side to an image side, intervals between lens groups adjacent to each other being changed during focusing, wherein the rear group includes a focus lens group A including at least one positive lens and at least one negative lens, wherein the focus lens group A moves toward the image side when focused from infinity to a close distance, wherein the front group includes a first lens group having a positive refractive power and a focus lens group B disposed in this order from the object side to the image side, wherein, during focusing from infinity to the close distance, the first lens group is stationary relative to an image plane, and the focus lens group A and the focus lens group B move in an optical axis direction relative to the image plane, wherein the focus lens group A moves in a direction including a component in a direction perpendicular to an optical axis to correct an image shake, and wherein the following conditional inequality is satisfied: 0.48≤(−β)≤5.00, where β denotes an image magnification of the optical system at a closest focus.

Features of the present disclosure will become apparent from the following description of embodiments with reference to the attached drawings. The following description of embodiments is described by way of example.

### BRIEF DESCRIPTION OF THE DRAWINGS

FIGS. 1A, 1B, and 1C are cross-sectional views illustrating an optical system L0 according to a first embodiment in an infinity-focus state, a state in which image magnification is −0.5×, and a state in which the image magnification is −1.0×, respectively.

FIGS. 2A, 2B, and 2C are aberration diagrams of the optical system L0 according to the first embodiment in the infinity-focus state, the state in which the image magnification is −0.5×, and the state in which the image magnification is −1.0×, respectively.

FIGS. 3A and 3B are transverse aberration diagrams of the optical system L0 according to the first embodiment in the infinity-focus state before an image position is displaced by 0.3 degrees and after the image position is displaced by 0.3 degrees, respectively.

FIGS. 4A, 4B, and 4C are cross-sectional views illustrating an optical system L0 according to a second embodiment in an infinity-focus state, a state in which image magnification is −0.5×, and a state in which the image magnification is −1.0×, respectively.

FIGS. 5A, 5B, and 5C are aberration diagrams of the optical system L0 according to the second embodiment in the infinity-focus state, the state in which the image magnification is −0.5×, and the state in which the image magnification is −1.0×, respectively.

FIGS. 6A and 6B are transverse aberration diagrams of the optical system L0 according to the second embodiment in the infinity-focus state before an image position is displaced by 0.3 degrees and after the image position is displaced by 0.3 degrees, respectively.

FIGS. 7A, 7B, and 7C are cross-sectional views illustrating an optical system L0 according to a third embodiment in an infinity-focus state, a state in which image magnification is −0.5×, and a state in which the image magnification is −1.0×, respectively.

FIGS. 8A, 8B, and 8C are aberration diagrams of the optical system L0 according to the third embodiment in the infinity-focus state, the state in which the image magnification is −0.5×, and the state in which the image magnification is −1.0×, respectively.

FIGS. 9A and 9B are transverse aberration diagrams of the optical system L0 according to the third embodiment in the infinity-focus state before an image position is displaced by 0.3 degrees and after the image position is displaced by 0.3 degrees, respectively.

FIGS. 10A, 10B, and 10C are cross-sectional views illustrating an optical system L0 according to a fourth embodiment in an infinity-focus state, a state in which image magnification is −0.5×, and a state in which the image magnification is −1.0×, respectively.

FIGS. 11A, 11B, and 11C are aberration diagrams of the optical system L0 according to the fourth embodiment in the infinity-focus state, the state in which the image magnification is −0.5×, and the state in which the image magnification is −1.0×, respectively.

FIGS. 12A and 12B are transverse aberration diagrams of the optical system L0 according to the fourth embodiment in the infinity-focus state before an image position is displaced by 0.3 degrees and after the image position is displaced by 0.3 degrees, respectively.

FIG. 13 is a schematic diagram of an imaging apparatus.

FIG. 14 is a schematic diagram of a lens apparatus.

### DESCRIPTION OF THE EMBODIMENTS

Embodiments disclosed in the present specification are described in detail below with reference to drawings. Note that the drawings may be drawn at a scale different from an actual scale for convenience. Further, in the drawings, the same members are denoted by the same reference numerals, and redundant descriptions thereof are omitted.

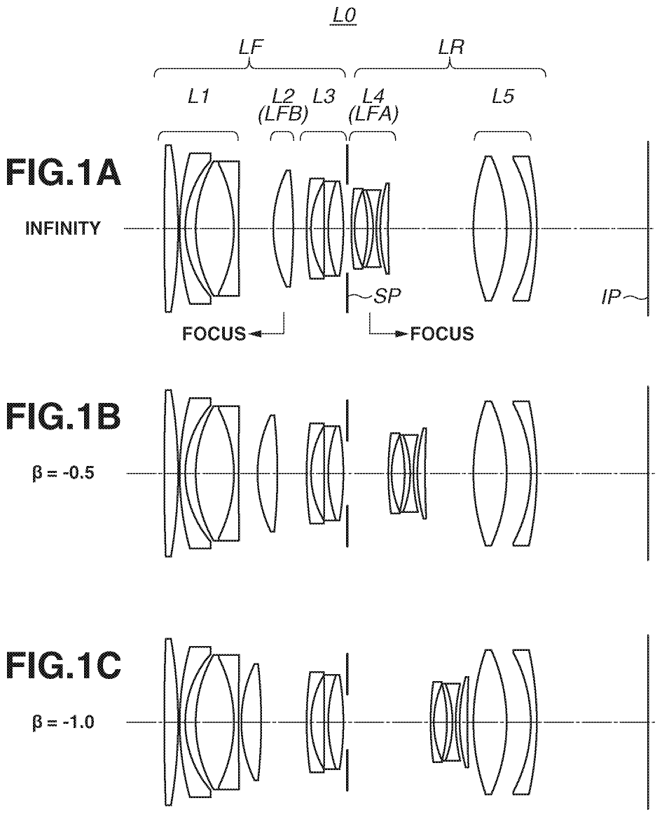

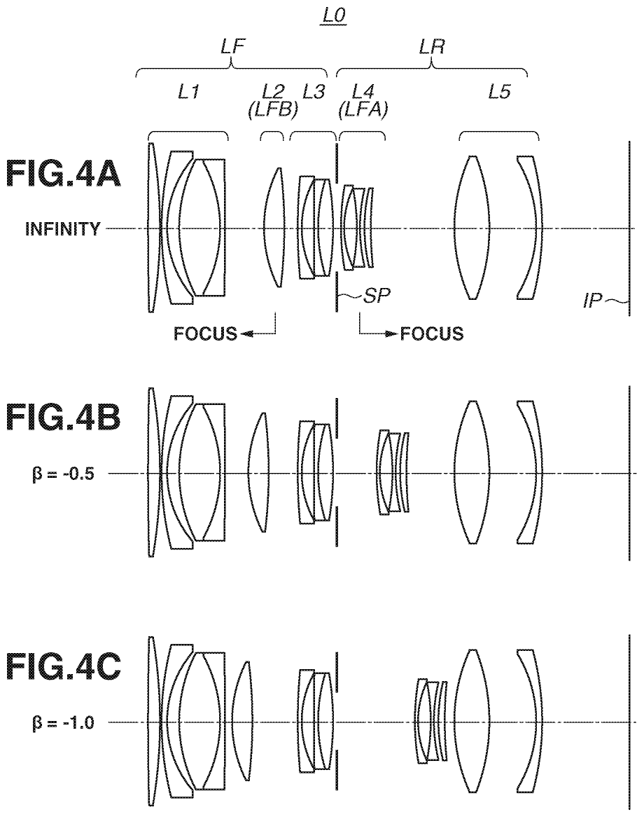

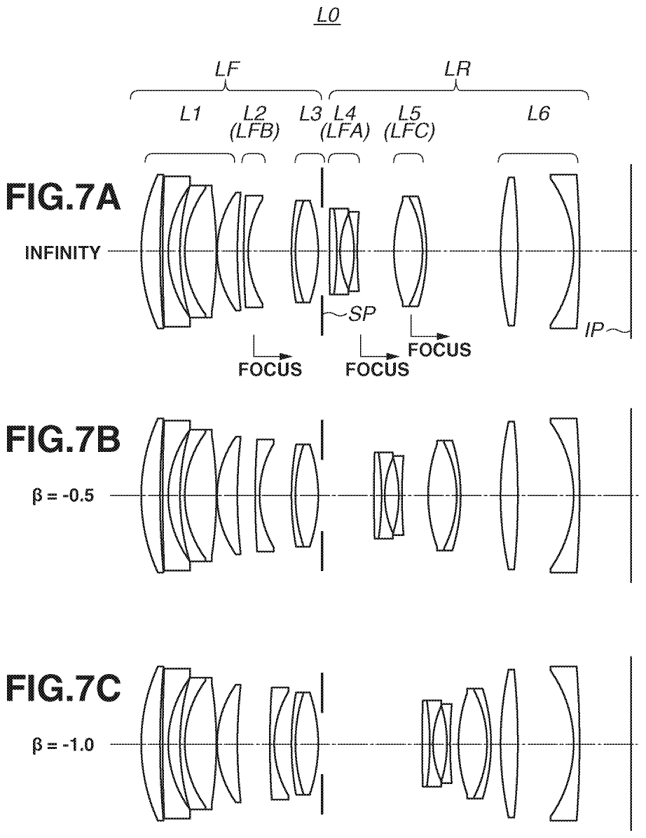

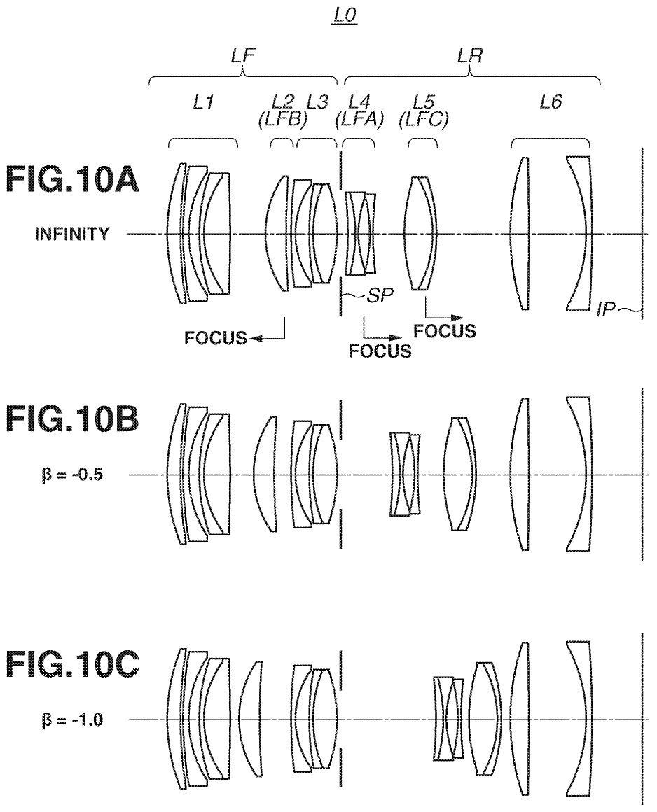

FIGS. 1A, 4A, 7A, and 10A are cross-sectional views obtained when optical systems L0 according to first to fourth embodiments are focused at infinity, respectively, FIGS. 1B, 4B, 7B, and 10B are cross-sectional views obtained when the optical systems L0 according to the first to fourth embodiments are focused in a state in which image magnification is −0.5×, and FIGS. 1C, 4C, 7C, and 10C are cross-sectional views obtained when the optical systems L0 according to the first to fourth embodiments are focused in a state in which the image magnification is −1.0×.

In each of the cross-sectional views, a left side is an object side, and a right side is an image side. The optical system L0 according to each of the embodiments is suitable for an imaging apparatus such as a digital video camera, a digital still camera, a broadcast camera, a silver-halide film camera, a monitoring camera, and an on-board camera. The optical system L0 according to each of the embodiments may also be used as a projection lens of a projector or the like. At this time, the left side is a screen side, and the right side is a projected image side.

In each of the cross-sectional views, L0 denotes the entire optical system, and Li denotes an i-th (i is a natural number) lens group counted from the object side among lens groups separated into lens groups on the object side and lens groups on the image side by an aperture stop. An interior of a lens group in the present disclosure refers to a space between a lens disposed on the most object side and a lens disposed on the most image side among lenses constituting the lens group.

The lens group Li is a group of lenses that move integrally or remain stationary relative to an image plane during focusing from infinity to a close distance. In other words, an air spacing between lens groups Li adjacent to each other is varied upon focusing, but an air spacing within each of the lens groups is not varied upon focusing. Each of the lens groups may consist of a plurality of lenses or a single lens.

An arrow parallel to an optical axis illustrated in each of the cross-sectional views indicates a moving direction of each of the lens groups that move during focusing from infinity to the close distance. In the present specification, a state of focusing on an object at infinity is referred to as an infinity focus state, and a state of focusing on an object at a minimum imaging distance is referred to as a closest focus state.

In each of the cross-sectional views, SP denotes an aperture stop that determines a light flux at an open F-number. IP denotes an image plane, and when the optical system L0 according to each of the embodiments is used as an imaging optical system L0 of a digital still camera or a digital video camera, an imaging surface of a solid-state imaging element or a photoelectric conversion element, such as a charge-coupled device (CCD) sensor or a complementary metal-oxide semiconductor (CMOS) sensor, is disposed at the image plane. The optical system L0 according to each of the embodiments may also be used as an imaging optical system L0 for a silver-halide film camera. In that case, a photosensitive surface corresponding to a film surface is disposed at the image plane IP.

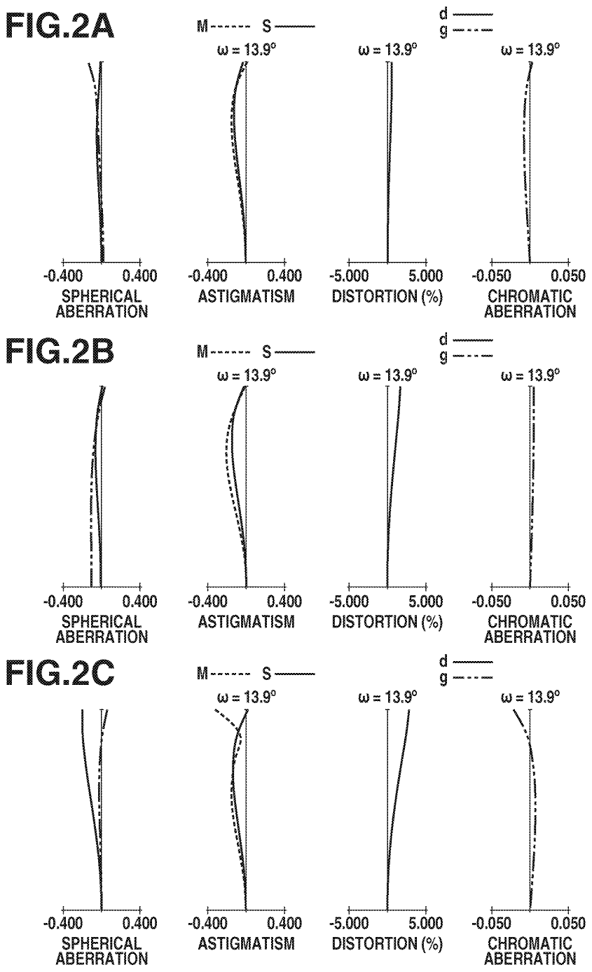

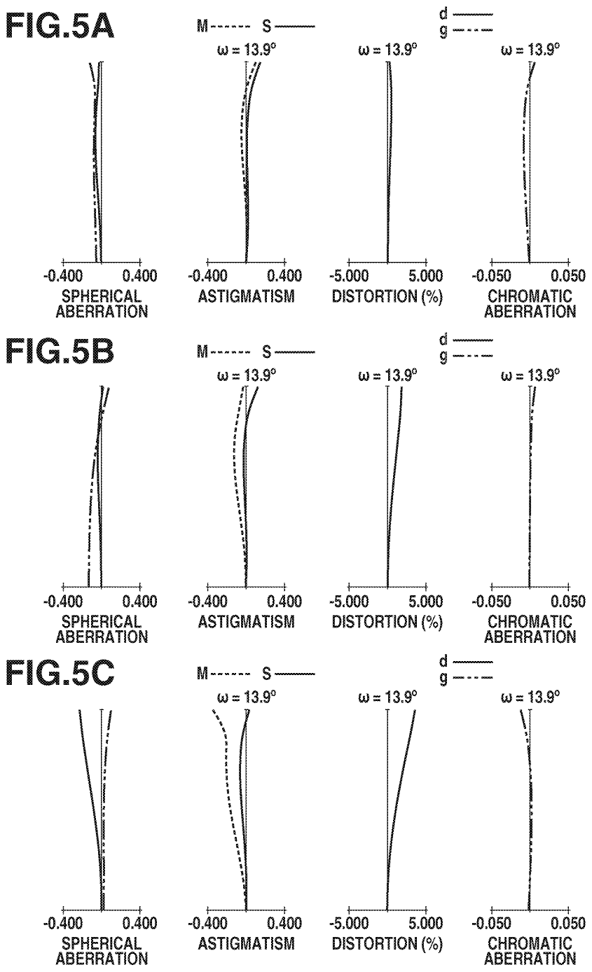

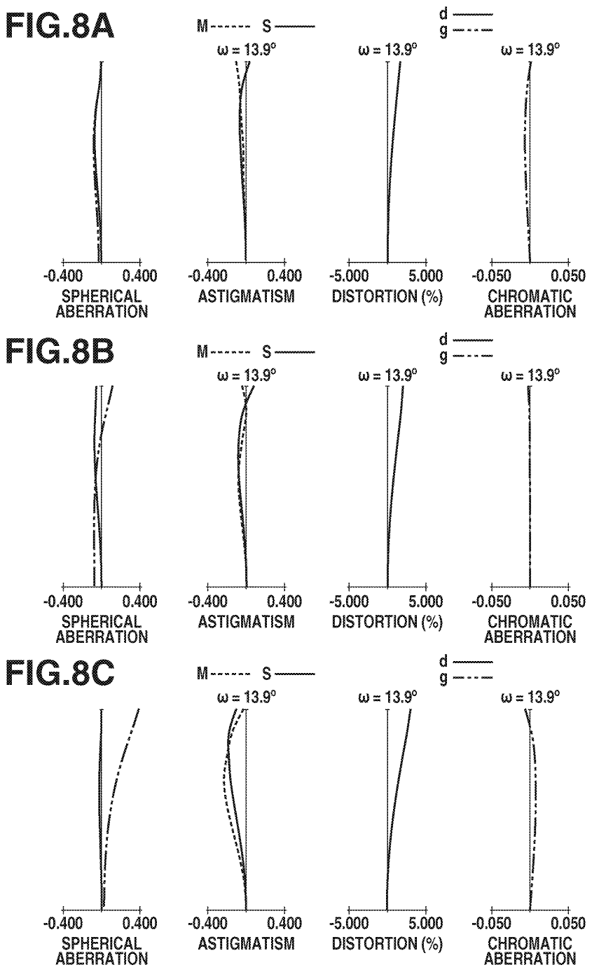

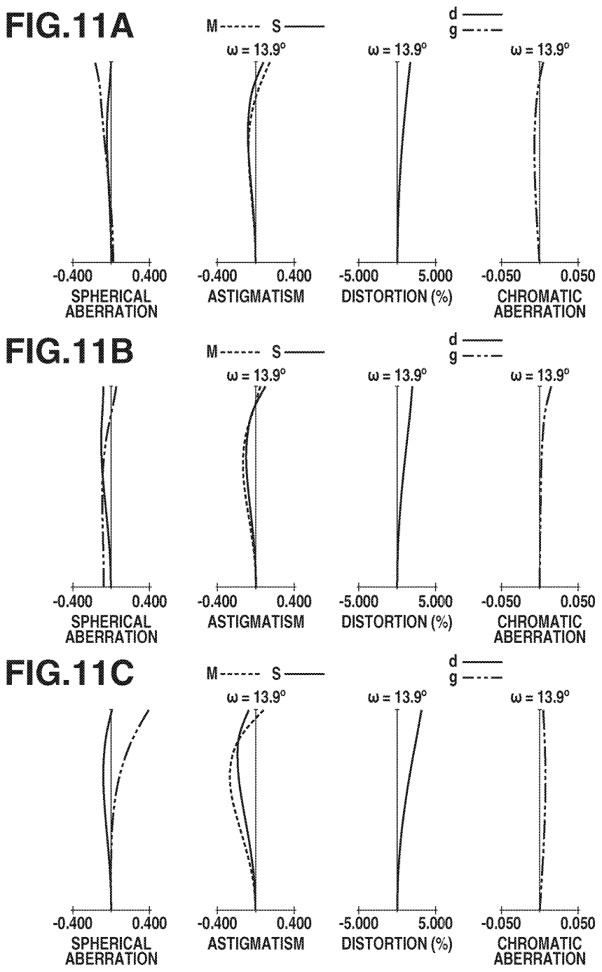

FIGS. 2A, 5A, 8A, and 11A are aberration diagrams when the optical systems L0 according to the first to fourth embodiments are focused at infinity, respectively, FIGS. 2B, 5B, 8B, and 11B are aberration diagrams when the optical systems L0 according to the first to fourth embodiments are focused in the state in which the image magnification is −0.5×, and FIGS. 2C, 5C, 8C, and 11C are aberration diagrams when the optical systems L0 according to the first to fourth embodiments are focused in the state in which the image magnification is −1.0×.

In each spherical aberration diagram, Fno represents an F-number. A solid line represents an amount of spherical aberration for the d-line (wavelength: 587.6 nm), and a dash-double-dot line represents an amount of spherical aberration for the g-line (wavelength: 435.8 nm). In each astigmatism diagram, a solid line S represents an amount of aberration on a sagittal image surface, and a broken line M represents an amount of aberration on a meridional image surface. In each distortion diagram, a solid line represents an amount of distortion for the d-line. In each chromatic aberration diagram, a dash-double-dot line represents an amount of chromatic aberration of magnification for the g-line. Further, ω denotes an imaging half angle of view (°).

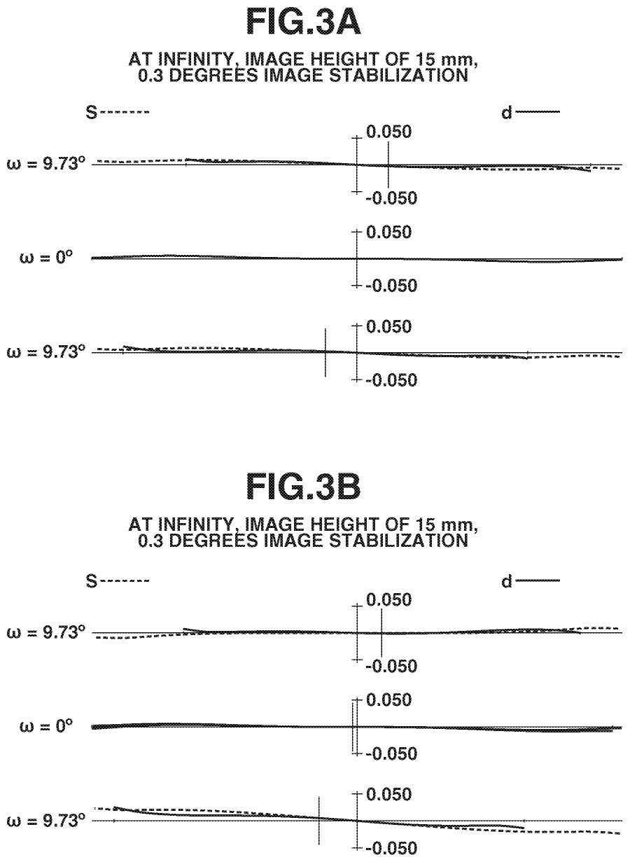

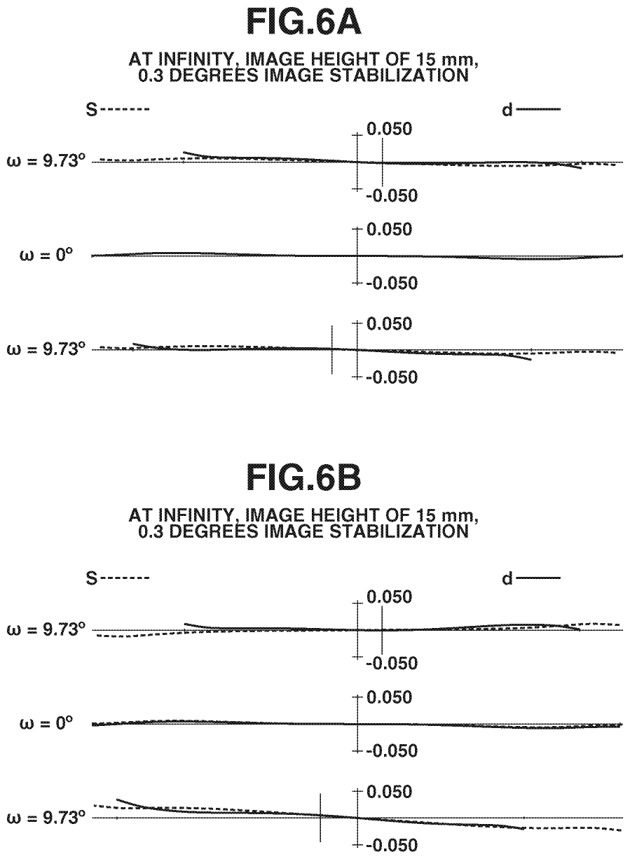

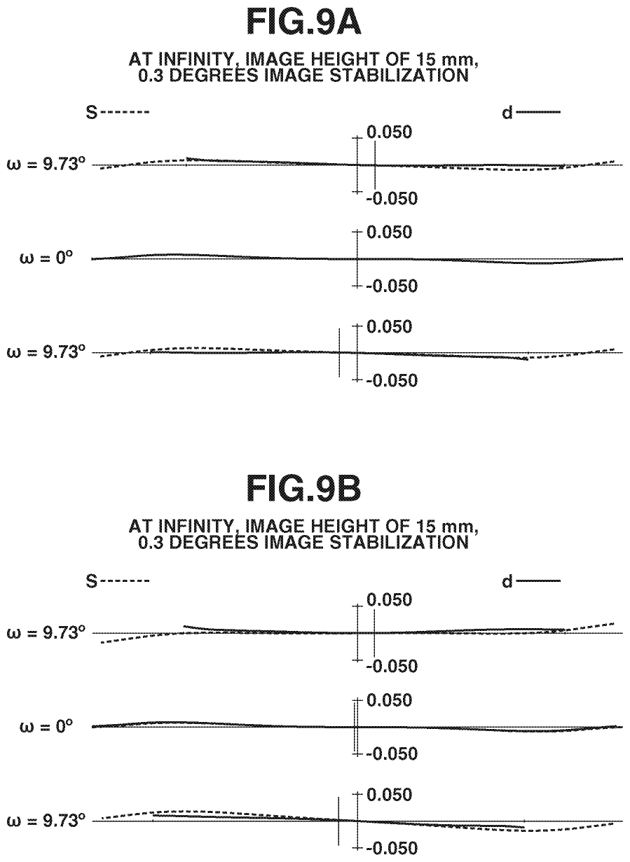

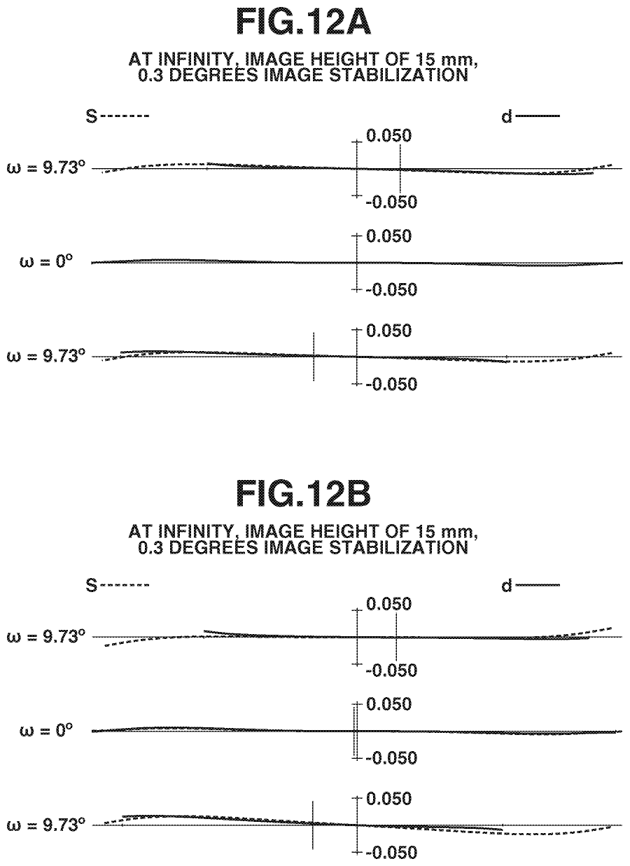

FIGS. 3A, 6A, 9A, and 12A are transverse aberration diagrams of the optical system L0 according to the first to fourth embodiments, respectively, in the infinity focus state before an image position shift of 0.3 degrees, and FIGS. 3B, 6B, 9B, and 12B are transverse aberration diagrams of the optical system L0 according to the first to fourth embodiments in the infinity focus state after the image position shift of 0.3 degrees.

Next, a characteristic configuration of the optical system L0 according to each of the embodiments is described.

The optical system L0 according to each of the embodiments includes, as in the first to fourth embodiments, a front group LF, an aperture stop SP, and a rear group LR disposed in this order from the object side to the image side. The front group LF and the rear group LR each include one or more lens groups for which an interval in an optical axis direction changes during focusing from infinity to the close distance. The rear group LR includes a focus lens group A that moves in the optical axis direction relative to the image plane during focusing from infinity to the close distance.

In the optical system L0 according to each of the embodiments, the focus lens group A moves in a direction including a component in a direction perpendicular to the optical axis to correct an image shake. By using the lens group that moves during focusing also as a lens group that moves for image stabilization, it is not necessary to separately provide an image stabilizing lens group, and it is possible to reduce the number of lenses constituting the optical system L0. Thus, the optical system L0 can be reduced in size in a radial direction. Further, by performing an image shake correction on the image side of the aperture stop SP, it is possible to suppress occurrence of spherical aberration and variation in field curvature.

By satisfying the above-described configuration, it is possible to realize the optical system L0 that is compact and has high optical performance while having an image stabilization function.

Next, a configuration that may be satisfied in the optical system L0 according to each of the embodiments is described.

In the optical system L0 according to each of the embodiments, a first lens group L1 disposed closest to the object side of the optical system L0 may have a positive refractive power. Accordingly, on-axis and off-axis light fluxes are converged. This makes it possible to favorably correct the chromatic aberration of magnification and the distortion, and to suppress variation in the field curvature associated with focusing.

In the optical system L0 according to each of the embodiments, the first lens group L1 may remain stationary relative to the image plane during focusing from infinity to the close distance. Accordingly, particularly during focusing at the close distance, changes in an amount of light entering the optical system L0 and a reduction in peripheral illuminance can be suppressed.

In the optical system L0 according to each of the embodiments, the front group LF may include a focus lens group B that moves in the optical axis direction during focusing. The focusing is performed by the plurality of lens groups, which makes it possible to favorably correct variations in various aberrations.

In the optical system L0 according to each of the embodiments, a lens group may be disposed on the image side of the focus lens group A. This makes it possible to suppress variations in various aberrations in the optical system L0 during focusing from infinity to the close distance.

In the optical system L0 according to each of the embodiments, the focus lens group A may include at least one positive lens and at least one negative lens. This makes it possible to suppress variation in axial chromatic aberration occurring upon focusing and to favorably correct the chromatic aberration over an entire focusing range. Further, since the focus lens group A moves during image stabilization, inclusion of at least one positive lens and at least one negative lens makes it possible to suppress decentering aberration.

In the optical system L0 according to each of the embodiments, the focus lens group B may consist of a single lens. This makes it possible to reduce a weight of the lens group that moves during focusing and to perform high-speed focusing.

In the optical system L0 according to each of the embodiments, the front group LF may further include a lens group that moves during focusing in addition to the focus lens group B. Similarly, the rear group LR may further include a lens group that moves during focusing in addition to the focus lens group A. In a case where a plurality of lens groups that move during focusing is present in the front group LF and the rear group LR, a lens group having a large absolute value of lateral magnification at infinity focus is defined as the focus lens group A and the focus lens group B.

In the optical system L0 according to each of the embodiments, a lens G1 disposed closest to the object side of the first lens group L1 may have a positive refractive power. By disposing the positive lens G1 closest to the object side of the optical system L0, it is possible to reduce an on-axis ray height of a lens disposed on the image side of the lens G1. Thus, it is possible to suppress coma aberration associated with focusing while favorably correcting the spherical aberration and the coma aberration.

In the optical system L0 according to each of the embodiments, a lens disposed closest to the image side may be a meniscus lens having a convex surface facing the image side. This makes it possible to correct the chromatic aberration of magnification occurring in the optical system L0 by the meniscus lens.

Next, conditions that may be satisfied in the optical system L0 according to each of the embodiments are described.

The optical system L0 according to each of the embodiments may satisfy at least one of the following conditional inequalities (1) to (12). In each of the conditional inequalities, various numerical values are denoted as follows.

An image magnification of the entire optical system L0 at the closest focus is denoted by β.

A focal length of the first lens group L1 is denoted by f1, a focal length of a second lens group L2 is denoted by f2, a focal length of the focus lens group A is denoted by fFA, and a focal length of the focus lens group B is denoted by fFB.

A back focus at infinity focus is denoted by sk. Here, the back focus is a distance from a surface vertex of an image-side lens surface of a lens disposed closest to the image plane in the optical system L0 to the image plane IP. In a case where an optical member having an extremely weak refractive power is disposed between the optical system L0 and an imaging element, as a value of the back focus, a value obtained by air-converting a value of the optical member having an extremely weak refractive power disposed between the optical system L0 and the imaging element is used.

A position sensitivity of the focus lens group A at infinity focus is denoted by ESAi, a position sensitivity in a state in which the image magnification is −0.5× is denoted by ESAh, and a position sensitivity in a state in which the image magnification is −1.0× is denoted by ESAm.

A position sensitivity of the focus lens group B at infinity focus is denoted by ESBi, a position sensitivity in the state in which the image magnification is −0.5× is denoted by ESBh, and a position sensitivity in the state in which the image magnification is −1.0× is denoted by ESBm.

A lateral magnification of the focus lens group A at infinity focus is denoted by βAi, a lateral magnification in the state in which the image magnification is −0.5× is denoted by βAh, and a lateral magnification in the state in which the image magnification is −1.0× is denoted by βAm.

A lateral magnification of the focus lens group B at infinity focus is denoted by βBi, a lateral magnification in the state in which the image magnification is −0.5× is denoted by βBh, and a lateral magnification in the state in which the image magnification is −1.0× is denoted by βBm.

An amount of movement of the focus lens group A during focusing from infinity to the state in which the image magnification is −0.5× is denoted by mAh, and an amount of movement of the focus lens group B during focusing from infinity to the state in which the image magnification is −0.5× is denoted by mBh.

When a combined lateral magnification of all lenses positioned on the image side of the focus lens group A is denoted by βR, an image shift sensitivity of the focus lens group A at infinity focus is denoted by TSAi, and an image shift sensitivity at the closest focus is denoted by TSAj. Here, an image shift sensitivity TS is a ratio between an amount of movement ΔL of a shift group in a direction perpendicular to the optical axis when the shift group is moved in the direction perpendicular to the optical axis and an amount of movement ΔI of an image (image forming position) on the image plane in the direction perpendicular to the optical axis at that time, and is expressed by the following equation:

$$TS = Δ I / Δ L .$$

The image shift sensitivity TS of the focus lens group A is expressed by the following expression:

$$TS = ( 1 - β A ) \times β R .$$

A position sensitivity of the focus lens group A at infinity focus is denoted by ESAi, and a position sensitivity at the closest focus is denoted by ESAj.

A position sensitivity of the focus lens group B at infinity focus is denoted by ESBi, and a position sensitivity at the closest focus is denoted by ESBj.

Here, a position sensitivity ES is a ratio of an amount of movement Δsk of an image forming position (focal position) in the optical axis direction when the movable lens group is moved by a distance Δx in the optical axis direction, and is expressed by the following equation:

$$ES = Δ sk / Δ x .$$

A shape factor SF is a shape factor of a lens L. When a focal length of the lens L is denoted by fL, a radius of curvature of an object-side surface is denoted by R1, and a radius of curvature of an image-side surface is denoted by R2, the shape factor SF is expressed by the following equation. In a case of an aspherical shape, R means a radius of a reference quadric surface. The term sgn denotes a sign function. In a case where the focal length fL of the lens L has a positive value, the sign function sgn is +1, whereas in a case where the focal length fL of the lens L has a negative value, the sign function sgn is −1.

$$SF = sgn ( fL ) \times ( R 2 + R 1 ) / ( R 2 - R 1 ) .$$

A shape factor of a positive lens G1p disposed closest to the object side in the first lens group L1 is denoted by SF1.

An average of refractive indices, for the d-line, of materials of all negative lenses included in the focus lens group B is denoted by nAave.

$$0.48 \leq ( - β ) \leq 5. \qquad ( 1 )$$

$$\vert TSAj \vert < \vert TSAi \vert \qquad ( 2 )$$

$$1. < \vert fFB / fFA \vert < 4. \qquad ( 3 )$$

$$0.7 < \vert f 1 / fB \vert < 8. \qquad ( 4 )$$

$$0.2 < f / f 1 < 2.4 \qquad ( 5 )$$

$$1. < \vert ESAi \vert < 5. \qquad ( 6 )$$

$$1. < \vert ESBi \vert < 5. \qquad ( 7 )$$

$$1. < \vert ESAh \vert < 5. \qquad ( 8 )$$

$$1. < \vert ESBh \vert < 5. \qquad ( 9 )$$

$$- 2. < SF 1 < 4. \qquad ( 10 )$$

$$1.48 < nAave < 1.7 \qquad ( 11 )$$

$$0.15 < \vert mBh / mAh \vert < 0.6 \qquad ( 12 )$$

The conditional inequality (1) defines a maximum imaging magnification of the optical system L0. When a value exceeds an upper limit of the conditional inequality (1), an absolute value of a lateral magnification when the imaging magnification is the maximum becomes excessively large. Accordingly, the optical system L0 is increased in size in the radial direction for image formation, which is not desirable. When the value falls below a lower limit of the conditional inequality (1), the lateral magnification when the imaging magnification is the maximum becomes small. Accordingly, resolution is reduced when an object is imaged in a sufficiently enlarged manner, which is not desirable.

Further, in the conditional inequality (1), it is desirable that the lower limit is set to 0.80 or 0.95 instead of 0.60, and the upper limit is set to 1.60 or 1.20 instead of 2.00, because the aberration can be corrected more favorably while the optical system L0 can be reduced in size.

The conditional inequality (2) defines the image shift sensitivity in image stabilization of the focus lens group B. When a value exceeds an upper limit of the conditional inequality (2), an amount of movement of the focus lens group B required to shift an image by a predetermined amount becomes large, which is undesirable because the optical system L0 is increased in size. Further, it is undesirable because it becomes difficult to suppress aberration variation when the focus lens group B is shifted to shift the image by the predetermined amount. When the value falls below a lower limit of the conditional inequality (2), the image is largely shifted in response to a minute movement of the focus lens group B, and variations in various aberrations become large, which is not desirable.

The conditional inequality (3) defines a ratio between the focal length of the focus lens group A and the focal length of the focus lens group B, and is an inequality for securing optical performance during focusing. In a case where the refractive power of the second lens group L2 is increased such that a value exceeds an upper limit of the conditional inequality (3), a refractive index of a material of the lens constituting the second lens group L2 becomes large in order to correct a Petzval sum, and correction of the chromatic aberration of magnification becomes insufficient, which is not desirable. In a case where the negative refractive power of a fourth lens group L4 is increased such that the value falls below a lower limit of the conditional inequality (3), an off-axis ray height from the fourth lens group L4 to a lens group on the image side becomes excessively high, and it becomes difficult to correct the chromatic aberration of magnification and the field curvature, which is not desirable.

The conditional inequality (4) defines a ratio between the focal lengths of the positive first lens group L1 and the focus lens group B constituting the front group LF, and is an inequality for securing optical performance during focusing.

By appropriately setting the ratio of the focal lengths of the first lens group L1 and the focus lens group B, the off-axis principal ray is easily caused to form a pupil image at a center of the aperture stop, and occurrence of the astigmatism and the distortion is easily suppressed.

Further, by disposing the positive lens closest to the object side, the spherical aberration when focused on an object at infinity is easily suppressed.

In a case where the refractive power of the focus lens group B is increased such that a value exceeds an upper limit of the conditional inequality (4), there are advantages in that the position sensitivity of the focus lens can be easily secured and the overall length can be easily reduced; however, this tends to cause correction insufficiency of the field curvature and the astigmatic difference over the entire focusing range. When the value falls below a lower limit of the conditional inequality (4), the light flux entering the focus lens group B is strongly converged, and variation in an aberration correction effect of the focus lens group B at infinity and the close distance is increased. This is undesirable because it becomes difficult to favorably correct the aberration over the entire focusing range.

The conditional inequality (5) defines a focal length f of the entire system by a focal length f1 of the first lens group L1, and is used to suppress variations in spherical aberration and coma aberration upon focusing.

When a value exceeds an upper limit of the conditional inequality (5), correction of the spherical aberration at infinity focus becomes insufficient, which is not desirable. When the value falls below a lower limit of the conditional inequality (5), a converging action of the first lens group L1 is reduced, and a lens diameter of a lens on the image side of the second lens group L2 is increased, which is not desirable.

The conditional inequalities (6) and (7) define the position sensitivities of the focus lens group A and the focus lens group B at infinity focus. In a case where the position sensitivities are high and exceed upper limits of the conditional inequalities (6) and (7), the focal position and various aberrations are largely varied due to a slight position change of the focus lens group, and it becomes difficult to secure high optical performance. As a result, it becomes difficult to adjust the focal position in the entire optical system L0, which is not desirable. When the values fall below lower limits of the conditional inequalities (6) and (7), the position sensitivities become excessively low, and a focal position adjustment becomes easy with respect to the position change of the focus lens group; however, the optical system L0 becomes large in size, which is not desirable.

The conditional inequalities (8) and (9) define the position sensitivities of the focus lens group A and the focus lens group B during focusing from infinity to the state in which the image magnification is −0.5×.

In a case where the position sensitivities are high and exceed upper limits of the conditional inequalities (8) and (9), it is advantageous for size reduction; however, it becomes difficult to correct the axial chromatic aberration and the spherical aberration on the close distance side, which is not desirable. In a case where the position sensitivities are low and fall below lower limits of the conditional inequalities (8) and (9), it is advantageous for correction of various aberrations; however, the amounts of movement of the focus lens group A and the focus lens group B are increased during focusing, and the optical system L0 becomes large in size, which is not desirable.

The conditional inequality (10) defines the shape factor of the positive lens G1p disposed closest to the object side in the first lens group L1.

When a value exceeds an upper limit of the conditional inequality (10), the radius of curvature of the object-side lens surface of the positive lens G1p becomes small, and correction of the spherical aberration at the closest focus becomes insufficient, which is not desirable. When the value falls below a lower limit of the conditional inequality (10), the radius of curvature of the image-side lens surface of the positive lens G1p becomes small, and correction of the spherical aberration at infinity focus becomes insufficient, which is not desirable.

The conditional inequality (11) defines the average refractive index nAave of negative lenses in the focus lens group A for the d-line, and defines a condition for correcting the various aberrations and securing optical performance in image stabilization.

When a value exceeds an upper limit of the conditional inequality (11), the refractive index of the negative lenses of the focus lens group A becomes excessively high, and correction of the axial chromatic aberration and the chromatic aberration of magnification becomes insufficient, which is not desirable. When the value falls below a lower limit of the conditional inequality (11), the refractive index of the negative lenses of the focus lens group A becomes excessively low, and a positive Petzval sum becomes excessively large, and it becomes difficult to correct the field curvature, which is not desirable. Further, it becomes difficult to correct the decentering coma aberration and the decentering astigmatic difference during image stabilization, which is not desirable.

The upper limit of the conditional inequality (11) may desirably be set to 1.69, 1.68, 1.67, 1.66, 1.65, 1.64, 1.63, 1.62, 1.61, 1.60, 1.59, or 1.58.

The lower limit of the conditional inequality (11) may desirably be set to 1.48, 1.49, 1.50, or 1.51.

The conditional inequality (12) defines a ratio between the amount of movement of the focus lens group A and the amount of movement of the focus lens group B during focusing from an object at infinity to the state in which the image magnification is −0.5×.

When the amount of movement of the focus lens group A becomes excessively small, and a value exceeds an upper limit of the conditional inequality (12), it is necessary to increase the refractive power of the focus lens group A. This is not desirable because it becomes difficult to correct the spherical aberration and the coma aberration by the focus lens group A. When the amount of movement of the focus lens group A becomes excessively large, and the value falls below a lower limit of the conditional inequality (12), it is necessary to decrease the refractive power of the focus lens group B. This is not desirable because a diameter of a lens disposed on the image side of the focus lens group B becomes large, and the optical system L0 becomes large in size.

Further, the numerical ranges of the conditional inequalities (1) to (12) may be set to ranges of conditional inequalities (1a) to (12a) below.

$$0.6 \leq ( - β ) \leq 2. \qquad ( 1 a )$$

$$\vert TSAj \vert / \vert TSAi \vert < 0.9 \qquad ( 2 a )$$

$$1.1 < \vert fFB / fFA \vert < 2.7 \qquad ( 3 a )$$

$$0.8 < \vert f 1 / fB \vert < 6.5 \qquad ( 4 a )$$

$$0.25 < f / f 1 < 2. \qquad ( 5 a )$$

$$1.5 < \vert ESAi \vert < 4.5 \qquad ( 6 a )$$

$$1.5 < \vert ESBi \vert < 4.5 \qquad ( 7 a )$$

$$1.3 < \vert ESAh \vert < 4.5 \qquad ( 8 a )$$

$$1.3 < \vert ESBh \vert < 4.5 \qquad ( 9 a )$$

$$- 1. < SF 1 < 3. \qquad ( 10 a )$$

$$1.5 < nAave < 1.65 \qquad ( 11 a )$$

$$0.2 < \vert mBh / mAh \vert < 0.55 \qquad ( 12 a )$$

Further, the numerical ranges of the conditional inequalities (1) to (12) may be set to ranges of the conditional inequalities (1b) to (12b) below.

$$0.8 \leq ( - β ) \leq 1.2 \qquad ( 1 b )$$

$$\vert TSAj \vert / \vert TSAi \vert < 0.9 \qquad ( 2 b )$$

$$1.2 < \vert fFB / fFA \vert < 2.1 \qquad ( 3 b )$$

$$0.9 < \vert f 1 / fB \vert < 5.7 \qquad ( 4 b )$$

$$0.3 < f / f 1 < 1.9 \qquad ( 5 b )$$

$$2. < \vert ESAi \vert < 4. \qquad ( 6 b )$$

$$2.5 < \vert ESBi \vert < 3.5 \qquad ( 7 b )$$

$$2.5 < \vert ESAh \vert < 3. \qquad ( 8 b )$$

$$2. < \vert ESBh \vert < 3.5 \qquad ( 9 b )$$

$$- 8. < SF 1 < 2.5 \qquad ( 10 b )$$

$$1.52 < nAave < 1.6 \qquad ( 11 b )$$

$$0.25 < \vert mBh / mAh \vert < 0.45 \qquad ( 12 b )$$

Next, a detailed configuration of the optical system L0 according to each of the first to fourth embodiments is described. In the optical system L0 according to each of the embodiments, description of a configuration similar to the configuration of the optical system L0 according to the first embodiment is omitted, and differences from the first embodiment are mainly described.

### First Embodiment

The optical system L0 according to the first embodiment includes a front group LF, an aperture stop SP, and a rear group LR disposed in this order from the object side to the image side. The front group LF includes a first lens group L1 having a positive refractive power, a second lens group L2 having a positive refractive power, and a third lens group L3 having a positive refractive power. The rear group LR includes the fourth lens group L4 having a negative refractive power, and a fifth lens group L5 having a positive refractive power. During focusing from infinity to the close distance, the second lens group L2 moves toward the object side in the optical axis direction, the fourth lens group L4 moves toward the image side in the optical axis direction, and the other lens groups remain stationary relative to the image plane. In other words, in the optical system L0 according to the first embodiment, the fourth lens group L4 corresponds to the focus lens group A, and the second lens group L2 corresponds to the focus lens group B. Further, during focusing from infinity to the close distance, all intervals between the lens groups adjacent to each other change.

By moving the plurality of lens groups upon focusing, it becomes possible to suppress variations in various aberrations occurring upon focusing. Further, since the first lens group L1 remains stationary relative to the image plane during focusing, it is possible to suppress the chromatic aberration of magnification and the distortion particularly at infinity. Furthermore, it is possible to suppress variation in field curvature accompanying focusing.

In the optical system L0 according to the first embodiment, the focus lens group A includes a negative lens, a cemented lens including a negative lens and a positive lens, and a positive lens disposed in this order from the object side to the image side. By disposing a negative meniscus lens closest to the object side in the focus lens group A, it is possible to favorably correct the field curvature and the coma aberration. Further, by disposing a single lens having a positive refractive power closest to the image side in the focus lens group A, it is possible to suppress the spherical aberration particularly at the close distance. Further, since the focus lens group A includes at least two negative lenses, it is possible to suppress the decentering coma aberration and the decentering field curvature that occur in image shake correction while securing the image shift sensitivity.

In the optical system L0 according to the first embodiment, the focus lens group A moves in a direction including a component in a direction perpendicular to the optical axis to correct an image shake. The optical system L0 can be reduced in size in the optical axis direction while occurrence of spherical aberration and variation in field curvature can be suppressed. Further, the focus lens group A disposed adjacent to the image side of the aperture stop SP has a small diameter as compared with those of other lens groups. Therefore, when the focus lens group A moves to correct image shake, an image stabilization mechanism can be reduced in size, and the optical system L0 can be reduced in size.

In the optical system L0 according to the first embodiment, the focus lens group B consists of a single positive lens. This makes it possible to reduce a weight of the focus lens group that moves during focusing. Further, it is possible to favorably correct the spherical aberration and the coma aberration particularly at the close distance.

In the optical system L0 according to the first embodiment, the first lens group L1 includes a positive lens, a negative lens, and a cemented lens consisting of a positive lens and a negative lens disposed in this order from the object side to the image side. By disposing the cemented lens consisting of the positive lens and the negative lens, it is possible to reduce variation in spherical aberration for each wavelength particularly at infinity. Further, it is possible to favorably correct variation in the coma aberration that is likely to occur particularly in a short wavelength range with field angle. The cemented lens has a strong convex shape on the object side, and accordingly, the spherical aberration and the coma aberration can be favorably corrected, which is desirable.

In the optical system L0 according to the first embodiment, the third lens group L3 includes a negative lens, and a cemented lens consisting of a negative lens and a positive lens disposed in this order from the object side to the image side. The third lens group L3 disposed on the object side of the aperture stop SP has the above-described configuration, which realizes a so-called telephoto-type power arrangement. Thus, the third lens group L3 can be reduced in size in the optical axis direction.

### Second Embodiment

The optical system L0 according to the second embodiment has a lens group configuration similar to the lens group configuration according to the first embodiment. In the optical system L0 according to the second embodiment, a focus lens group A includes a negative lens, a negative lens, and a positive lens disposed in this order from the object side to the image side. The focus lens group A, which moves upon focusing and in image shake correction, includes three lenses, which makes it possible to reduce a focusing mechanism and an image stabilization mechanism in size, and to reduce the optical system L0 in size.

### Third Embodiment

The optical system L0 according to the third embodiment includes a front group LF, an aperture stop SP, and a rear group LR disposed in this order from the object side to the image side. The front group LF consists of a first lens group L1 having a positive refractive power, a second lens group L2 having a negative refractive power, and a third lens group L3 having a positive refractive power. The rear group LR consists of a fourth lens group L4 having a negative refractive power, a fifth lens group L5 having a positive refractive power, and a sixth lens group L6 having a positive refractive power. During focusing from infinity to the close distance, the second lens group L2, the fourth lens group L4, and the fifth lens group L5 move toward the image side in the optical axis direction, and the other lens groups remain stationary relative to the image plane. In other words, in the optical system L0 according to the third embodiment, the fourth lens group L4 corresponds to the focus lens group A, the second lens group corresponds to the focus lens group B, and the fifth lens group L5 corresponds to a focus lens group C. Further, during focusing from infinity to the close distance, all intervals between the lens groups adjacent to each other change. The focus lens group A moves in a direction including a component in a direction perpendicular to the optical axis in order to correct an image shake.

In the optical system L0 according to the third embodiment, the first lens group L1 includes a positive lens, a negative lens, a cemented lens consisting of a negative lens and a positive lens, and a positive lens disposed in this order from the object side to the image side. By disposing the cemented lens consisting of the positive lens and the negative lens, it is possible to reduce variation in spherical aberration for each wavelength particularly at infinity. Further, it is possible to favorably correct variation in the coma aberration that is likely to occur particularly in a short wavelength range with field angle. The cemented lens has a strong convex shape on the object side, and accordingly, the spherical aberration and the coma aberration can be favorably corrected, which is desirable. Further, since the first lens group L1 includes three positive lenses, the positive refractive power of the entire first lens group can be enhanced. Therefore, the light flux entering the first lens group L1 is strongly converged, and the optical system L0 can be reduced in size in the optical axis direction.

In the optical system L0 according to the third embodiment, the focus lens group B consists of a single negative lens. This makes it possible to reduce a weight of the focus lens group that moves during focusing and to reduce the amount of movement of the focus lens group B.

The optical system L0 according to the third embodiment includes the focus lens group C that has a positive refractive power and is disposed adjacent to the image side of the focus lens group A. This makes it possible to favorably correct the field curvature and the coma aberration during focusing.

### Fourth Embodiment

The optical system L0 according to the fourth embodiment includes a front group LF, an aperture stop SP, and a rear group LR disposed in this order from the object side to the image side. The front group LF includes a first lens group L1 having a positive refractive power, a second lens group L2 having a positive refractive power, and a third lens group L3 having a positive refractive power. The rear group LR includes a fourth lens group L4 having a negative refractive power, a fifth lens group L5 having a positive refractive power, and a sixth lens group L6 having a positive refractive power.

During focusing from infinity to the close distance, the second lens group L2 moves toward the object side in the optical axis direction, the fourth lens group L4 and the fifth lens group L5 move toward the image side in the optical axis direction, and the other lens groups remain stationary relative to the image plane. In other words, in the optical system L0 according to the fourth embodiment, the fourth lens group L4 corresponds to the focus lens group A, the second lens group L2 corresponds to the focus lens group B, and the fifth lens group L5 corresponds to the focus lens group C. Further, during focusing from infinity to the close distance, all intervals between the lens groups adjacent to each other change. The focus lens group A moves in a direction including a component in a direction perpendicular to the optical axis in order to correct an image shake.

In the optical system L0 according to the fourth embodiment, the front group LF includes three lens groups each having a positive refractive power that are disposed successively. This makes it possible to reduce the positive refractive power per lens group and to reduce the diameter of each of the lens groups.

In the optical system L0 according to the fourth embodiment, the first lens group L1 includes a positive lens, a negative lens, and a cemented lens consisting of a negative lens and a positive lens disposed in this order from the object side to the image side. By disposing the cemented lens consisting of the positive lens and the negative lens, it is possible to reduce variation in spherical aberration for each wavelength particularly at infinity. Further, it is possible to favorably correct variation in the coma aberration that is likely to occur particularly in a short wavelength range with field angle. The cemented lens has a strong convex shape on the object side, and accordingly, the spherical aberration and the coma aberration can be favorably corrected, which is desirable.

First to fourth numerical examples corresponding to the first to fourth embodiments, respectively, are described below.

In surface data in each of the numerical examples, r denotes a radius of curvature of each optical surface, and d (mm) denotes a distance between an m-th surface and an (m+1)-th surface on the optical axis, where m is a surface number counted from a light incident side. Further, nd denotes a refractive index of each optical member for the d-line, and νd denotes an Abbe number of each optical member. In addition, the Abbe number νd and a partial dispersion ratio θgF of a certain material are expressed as follows, where Nd, NF, NC, and Ng denote refractive indexes for the d-line (587.6 nm), F-line (486.1 nm), C-line (656.3 nm), and g-line (wavelength of 435.8 nm) of the Fraunhofer lines.

$$vd = ( Nd - 1 ) / ( NF - NC )$$

$$θ gF = ( Ng - NF ) / ( NF - NC )$$

In each of the numerical examples, d, a focal length (mm), an F-number Fno, and a half angle of view ω (°) all have values when the optical system according to each of the embodiments is focused on an object at infinity. A back focus BF is an air-converted distance from a final lens surface to the image plane. A total optical length is a value obtained by adding the air-converted back focus to a distance from a first lens surface to the final lens surface. However, optical members corresponding to an optical filter, a face plate, a quartz low-pass filter, an infrared-cut filter, and the like are not included.

[First Numerical Example]
Unit mm
Surface Data

| Surface No. | r | d | nd | νd | θgF |
|---|---|---|---|---|---|
| 1 | 594.1085 | 3.470 | 1.76182 | 26.52 | 0.6136 |
| 2 | −120.8555 | 0.400 | | | |
| 3 | 69.6803 | 1.400 | 1.51680 | 64.20 | 0.5342 |
| 4 | 25.7397 | 2.515 | | | |
| 5 | 33.7052 | 9.601 | 1.59282 | 68.62 | 0.5458 |
| 6 | −35.6156 | 1.200 | 1.90366 | 31.32 | 0.5946 |
| 7 | 1165.0388 | (variable) | | | |
| 8 | 33.2611 | 4.994 | 1.57144 | 71.61 | 0.5426 |
| 9 | −133.4691 | (variable) | | | |
| 10 | 88.4354 | 1.100 | 1.64769 | 33.84 | 0.5925 |
| 11 | 22.8321 | 3.333 | | | |
| 12 | −917.8456 | 1.000 | 1.75211 | 25.05 | 0.6190 |
| 13 | 36.2932 | 3.801 | 2.00100 | 29.13 | 0.5997 |
| 14 | −71.7736 | 1.000 | | | |
| 15 (diaphragm) | ∞ | (variable) | | | |
| 16 | 77.0029 | 0.800 | 1.55032 | 75.50 | 0.5405 |
| 17 | 23.2345 | 3.281 | | | |
| 18 | −37.1819 | 1.405 | 1.84666 | 23.79 | 0.6191 |
| 19 | −26.6049 | 0.800 | 1.59551 | 39.22 | 0.5810 |
| 20 | 41.0087 | 0.998 | | | |
| 21 | 42.4018 | 1.942 | 1.86966 | 20.02 | 0.6434 |
| 22 | 235.2000 | (variable) | | | |
| 23 | 53.5773 | 8.367 | 1.61997 | 63.88 | 0.5417 |
| 24 | −43.5300 | 6.053 | | | |
| 25 | −36.2747 | 1.500 | 1.94594 | 17.98 | 0.6546 |
| 26 | −82.8322 | 27.952 | | | |
| Image plane | ∞ | | | | |

Various Kinds of Data

| | |
|---|---|
| Focal length | 87.500 |
| F-number | 2.880 |
| Half angle of view | 13.888 |
| Image height | 21.635 |
| Total optical length | 121.427 |
| BF | 27.952 |

| | ∞ | −0.5× | −1.0× |
|---|---|---|---|
| d7 | 8.699 | 4.729 | 0.663 |
| d9 | 3.373 | 4.473 | 12.509 |
| d15 | 1.000 | 10.309 | 20.935 |
| d22 | 21.444 | 12.135 | 1.509 |

Lens Group Data

| Group | Starting surface | Focal length |
|---|---|---|
| L1 | 1 | 249.272 |
| L2 (LFB) | 8 | 47.107 |
| L3 | 10 | 985.624 |
| L4 (LFA) | 16 | −37.085 |
| L5 | 23 | 74.864 |

[Second Numerical Example]
Unit mm
Surface Data

| Surface No. | r | d | nd | νd | θgF |
|---|---|---|---|---|---|
| 1 | 796.6172 | 3.001 | 1.76182 | 26.52 | 0.6136 |
| 2 | −124.2417 | 0.400 | | | |
| 3 | 75.2132 | 1.400 | 1.51680 | 64.20 | 0.5342 |
| 4 | 26.2908 | 2.737 | | | |
| 5 | 36.6184 | 10.286 | 1.59282 | 68.62 | 0.5458 |
| 6 | −33.7151 | 1.200 | 1.85883 | 30.00 | 0.5980 |
| 7 | −1547.0599 | (variable) | | | |
| 8 | 32.7048 | 5.100 | 1.55032 | 75.50 | 0.5405 |
| 9 | −120.8871 | (variable) | | | |
| 10 | 135.6074 | 1.000 | 1.68893 | 31.16 | 0.5988 |
| 11 | 24.5104 | 3.140 | | | |
| 12 | 2211.1031 | 1.000 | 1.68430 | 26.81 | 0.6230 |
| 13 | 40.6136 | 3.737 | 2.00100 | 29.13 | 0.5997 |
| 14 | −71.3675 | 1.000 | | | |
| 15 (diaphragm) | ∞ | (variable) | | | |
| 16 | 59.6315 | 0.800 | 1.55032 | 75.50 | 0.5405 |
| 17 | 22.8947 | 3.185 | | | |
| 18 | −49.9186 | 0.800 | 1.59282 | 68.62 | 0.5458 |
| 19 | 41.1741 | 1.130 | | | |
| 20 | 41.7903 | 1.592 | 1.94594 | 17.98 | 0.6546 |
| 21 | 96.0462 | (variable) | | | |
| 22 | 42.4730 | 8.808 | 1.55032 | 75.50 | 0.5405 |
| 23 | −48.6043 | 11.775 | | | |
| 24 | −32.2136 | 1.500 | 1.98612 | 16.48 | 0.6657 |
| 25 | −67.3924 | 21.969 | | | |
| Image plane | ∞ | | | | |

Various Kinds of Data

| | |
|---|---|
| Focal length | 87.500 |
| F-number | 2.880 |
| Half angle of view | 9.728 |
| Image height | 15.000 |
| Total optical length | 120.782 |

| | ∞ | −0.5× | −1.0× |
|---|---|---|---|
| d7 | 9.846 | 5.915 | 1.819 |
| d9 | 3.373 | 7.304 | 11.400 |
| d15 | 1.000 | 9.965 | 19.586 |
| d21 | 21.002 | 12.038 | 2.416 |

Lens Group Data

| Group | Starting surface | Focal length |
|---|---|---|
| L1 | 1 | 253.703 |
| L2 (LFB) | 8 | 47.332 |
| L3 | 10 | 723.355 |
| L4 (LFA) | 16 | −35.338 |
| L5 | 22 | 76.832 |

[Third Numerical Example]
Unit mm
Surface Data

| Surface No. | r | d | nd | νd | θgF |
|---|---|---|---|---|---|
| 1 | 46.3623 | 4.753 | 1.84666 | 23.84 | 0.6202 |
| 2 | 214.0170 | 0.500 | | | |
| 3 | 492.4091 | 1.400 | 1.54072 | 47.20 | 0.5672 |
| 4 | 27.4377 | 2.959 | | | |
| 5 | 56.5287 | 1.200 | 2.00069 | 25.46 | 0.6136 |
| 6 | 26.2728 | 7.953 | 1.55032 | 75.50 | 0.5405 |
| 7 | −99.1125 | 0.200 | | | |
| 8 | 25.2391 | 5.105 | 1.59282 | 68.62 | 0.5458 |
| 9 | 126.7915 | (variable) | | | |
| 10 | 203.8236 | 1.100 | 1.57144 | 71.61 | 0.5426 |
| 11 | 25.2949 | (variable) | | | |
| 12 | 71.2846 | 1.000 | 1.75211 | 25.05 | 0.6190 |
| 13 | 40.1988 | 5.744 | 1.61997 | 63.88 | 0.5417 |
| 14 | −38.7783 | 1.000 | | | |
| 15 (diaphragm) | ∞ | (variable) | | | |
| 16 | 397.7759 | 1.910 | 1.92286 | 20.88 | 0.6391 |
| 17 | −78.2375 | 0.800 | 1.55032 | 75.50 | 0.5405 |
| 18 | 22.2779 | 3.530 | | | |
| 19 | −31.8064 | 0.800 | 1.53775 | 74.70 | 0.5392 |
| 20 | 118.9615 | (variable) | | | |
| 21 | 37.9111 | 7.194 | 1.49700 | 81.61 | 0.5386 |
| 22 | −28.6969 | 1.000 | 2.05090 | 26.94 | 0.6054 |
| 23 | −45.6674 | (variable) | | | |
| 24 | 85.0385 | 4.350 | 1.75500 | 52.32 | 0.5475 |
| 25 | −184.1920 | 14.053 | | | |
| 26 | −31.5634 | 1.496 | 1.49700 | 81.61 | 0.5386 |
| 27 | −250.7837 | 12.985 | | | |
| Image plane | ∞ | | | | |

Various Kinds of Data

| | |
|---|---|
| Focal length | 87.500 |
| F-number | 2.880 |
| Half angle of view | 13.888 |
| Image height | 21.635 |
| Total optical length | 123.262 |
| BF | 12.985 |

| | ∞ | −0.5× | −1.0× |
|---|---|---|---|
| d9 | 1.600 | 4.493 | 8.181 |
| d11 | 10.918 | 8.025 | 4.337 |
| d15 | 1.800 | 13.051 | 25.202 |
| d20 | 9.250 | 6.610 | 2.102 |
| d23 | 18.662 | 10.052 | 2.409 |

Lens Group Data

| Group | Starting surface | Focal length |
|---|---|---|
| L1 | 1 | 47.222 |
| L2 (LFB) | 10 | −50.650 |
| L3 | 12 | 43.933 |
| L4 (LFA) | 16 | −24.882 |
| L5 (LFC) | 21 | 60.089 |
| L6 | 24 | 521.441 |

[Fourth Numerical Example]
Unit mm
Surface Data

| Surface No. | r | d | nd | νd | θgF |
|---|---|---|---|---|---|
| 1 | 47.1590 | 3.398 | 1.84666 | 23.84 | 0.6202 |
| 2 | 111.4836 | 0.500 | | | |
| 3 | 98.0994 | 1.400 | 1.51742 | 52.15 | 0.5585 |
| 4 | 27.9047 | 2.620 | | | |
| 5 | 45.2275 | 1.200 | 2.00069 | 25.46 | 0.6136 |
| 6 | 24.5558 | 6.677 | 1.55032 | 75.50 | 0.5405 |
| 7 | −302.6932 | (variable) | | | |
| 8 | 25.4873 | 5.265 | 1.59282 | 68.62 | 0.5458 |
| 9 | 196.2601 | (variable) | | | |
| 10 | 116.9177 | 1.100 | 1.50445 | 55.20 | 0.5482 |
| 11 | 21.3175 | 3.198 | | | |
| 12 | 67.2960 | 1.000 | 1.51742 | 52.15 | 0.5585 |
| 13 | 32.3979 | 6.067 | 1.49700 | 81.61 | 0.5386 |
| 14 | −37.5481 | 1.000 | | | |
| 15 (diaphragm) | ∞ | (variable) | | | |
| 16 | −99.6086 | 1.891 | 1.94594 | 17.98 | 0.6546 |
| 17 | −40.0494 | 0.800 | 1.55032 | 75.50 | 0.5405 |
| 18 | 26.2223 | 2.930 | | | |
| 19 | −37.2743 | 0.800 | 1.49700 | 81.61 | 0.5386 |
| 20 | 85.5258 | (variable) | | | |
| 21 | 44.1751 | 7.226 | 1.51680 | 64.20 | 0.5342 |
| 22 | −28.6605 | 1.000 | 2.00272 | 19.32 | 0.6452 |
| 23 | −42.8832 | (variable) | | | |
| 24 | 61.2226 | 4.689 | 1.69680 | 55.46 | 0.5430 |
| 25 | −892.8761 | 14.650 | | | |
| 26 | −38.0999 | 1.496 | 1.58144 | 40.89 | 0.5767 |
| 27 | −267.3512 | 12.820 | | | |
| Image plane | ∞ | | | | |

Various Kinda of Data

| | |
|---|---|
| Focal length | 87.500 |
| F-number | 2.880 |
| Half angle of view | 13.888 |
| Image height | 21.635 |
| Total optical length | 120.964 |
| BF | 12.820 |

| | ∞ | −0.5× | −1.0× |
|---|---|---|---|
| d7 | 9.000 | 5.998 | 2.258 |
| d9 | 1.600 | 4.602 | 8.342 |
| d15 | 1.800 | 13.191 | 24.276 |
| d20 | 7.996 | 6.666 | 2.035 |
| d23 | 18.842 | 8.781 | 2.326 |

Lens Group Data

| Group | Starting surface | Focal length |
|---|---|---|
| L1 | 1 | 275.594 |
| L2 (LFB) | 8 | 48.849 |
| L3 | 10 | 340.931 |
| L4 (LFA) | 16 | −24.220 |
| L5 (LFC) | 21 | 56.119 |
| L6 | 24 | 558.806 |

Various values in the numerical examples are summarized in Table 1 below.

TABLE 1

| | First | Second | Third | Fourth |
|---|---|---|---|---|
| | example | example | example | example |
| f | 87.500 | 87.500 | 87.500 | 87.500 |
| TD | 93.475 | 98.813 | 110.277 | 108.144 |
| sk | 27.952 | 21.969 | 12.985 | 12.820 |
| TL | 121.427 | 120.782 | 123.262 | 120.964 |
| −β | 1.000 | 1.000 | 1.000 | 1.000 |
| ESAi | −3.230 | −3.330 | −3.707 | −3.559 |
| ESAh | −2.859 | −2.997 | −3.322 | −3.176 |
| ESAm = ESAj | −2.462 | −2.658 | −2.870 | −2.851 |
| ESBi | 3.786 | 3.800 | −3.229 | 3.632 |
| ESBh | 3.408 | 3.445 | −2.524 | 3.106 |
| ESBm = ESBj | 2.569 | 2.675 | −1.716 | 2.277 |
| TSAi | −1.432 | −1.499 | −1.997 | −2.033 |
| TSAj | −1.210 | −1.308 | −1.561 | −1.606 |
| mAh | 9.309 | 8.965 | 11.251 | 11.391 |
| mBh | 3.970 | 3.931 | 2.893 | 3.002 |
| f1 | 249.272 | 253.703 | 47.222 | 275.594 |
| f2 | 47.107 | 47.332 | −50.650 | 48.849 |
| f3 | 985.624 | 723.355 | 43.933 | 340.931 |
| f4 | −37.085 | −35.338 | −24.882 | −24.220 |
| f5 | 74.864 | 76.832 | 60.089 | 56.119 |
| f6 | | | 521.441 | 558.806 |
| fA | −37.08 | −35.34 | −24.88 | −24.22 |
| fB | 47.107 | 47.332 | −50.650 | 48.849 |
| Pr1 | 594.109 | 796.617 | 46.3623 | 47.1590 |
| Pr2 | −120.8555 | −124.2417 | 214.0170 | 111.4836 |
| ndP | 1.76182 | 1.76182 | 1.84666 | 1.84666 |
| vdP | 26.52 | 26.52 | 23.84 | 23.84 |
| θgFP | 0.6136 | 0.6136 | 0.6202 | 0.6202 |
| (3) \|fB/fA\| | 1.2703 | 1.3394 | 2.0356 | 2.0169 |
| (4) \|f1/fB | 5.2916 | 5.3600 | 0.9323 | 5.6417 |
| (5) f/f1 | 0.3510 | 0.3449 | 1.8530 | 0.3175 |
| (10) SF1 | −0.662 | −0.730 | 1.553 | 2.466 |
| (11) nAave | 1.5729 | 1.5716 | 1.5440 | 1.5237 |
| (12) \|mBh/mAh\| | 0.4265 | 0.4385 | 0.2571 | 0.2635 |

### [Imaging Apparatus]

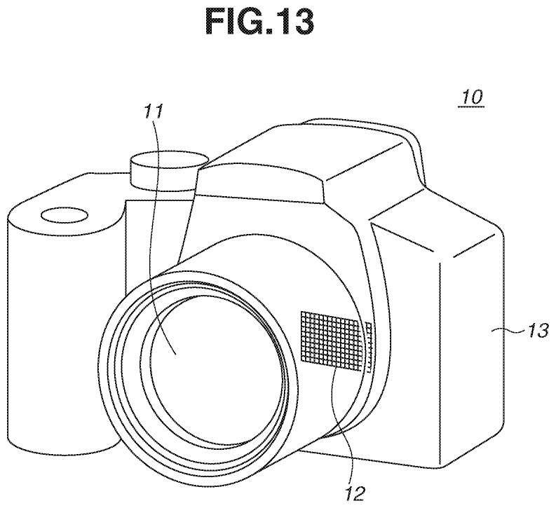

Next, an embodiment of an imaging apparatus 10 in which the optical system L0 according to each of the embodiments is used as an imaging optical system L0 is described with reference to FIG. 13. In FIG. 13, a reference numeral 13 denotes a camera main body, and a reference numeral 11 denotes the imaging optical system L0 configured by the optical system L0 according to any one of the first to fourth embodiments. A reference numeral 12 is a solid-state imaging element (photoelectric conversion element) such as a CCD sensor or a CMOS sensor that is incorporated in the camera main body 13 and receives an optical image formed by the imaging optical system L0 to perform photoelectric conversion. The camera main body 13 may be a so-called single-lens reflex camera including a quick return mirror, or may be a so-called mirrorless camera including no quick return mirror.

The optical system L0 according to each of the above-described embodiments is not limited to the digital still camera illustrated in FIG. 13 and can be applied to various optical apparatuses such as a silver-halide film camera, a video camera, and a telescope. Further, the camera may be of a lens-integrated type or an interchangeable-lens type.

### [Lens Apparatus]

Next, an embodiment of a lens apparatus including the optical system L0 according to each of the embodiments is described.

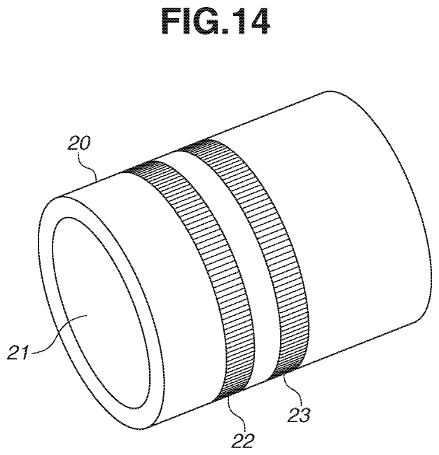

FIG. 14 is a schematic external view of a lens apparatus including the optical system L0 according to each of the embodiments. The lens apparatus illustrated in FIG. 14 is a so-called interchangeable lens detachably mountable on a camera main body (not illustrated).

A lens apparatus 20 includes an imaging optical system 21 that is similar to the optical system L0 according to any one of the above-described first to fourth embodiments. The lens apparatus 20 includes a focus operation unit 22 and an operation unit 23 configured to change an imaging mode.

By a user operating the focus operation unit 22, an arrangement in the imaging optical system 21 is mechanically or electrically changed to change a focal position. The user may operate the operation unit 23 to change an arrangement of lens groups in the imaging optical system 21 for a purpose other than focusing. For example, an arrangement of the lens groups in the imaging optical system 21 may be mechanically or electrically changed in accordance with an operation of the operation unit 23 to change aberrations of the imaging optical system 21. In this case, the focal position may not be substantially changed.

Although embodiments of the present disclosure have been described above, the present disclosure is not limited to these embodiments, and various combinations, modifications, and changes can be made within the scope of the gist of the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-051861, filed Mar. 26, 2025, which is hereby incorporated by reference herein in its entirety.

What is claimed is:

1. An optical system comprising:
a front group including one or more lens groups, an aperture stop, and a rear group including one or more lens groups, the front group, the aperture stop, and the rear group being disposed in this order from an object side to an image side, intervals between lens groups adjacent to each other being changed during focusing,
wherein the rear group includes a focus lens group A including at least one positive lens and at least one negative lens,
wherein the focus lens group A moves toward the image side when focused from infinity to a close distance,
wherein the front group includes a first lens group having a positive refractive power and a focus lens group B disposed in this order from the object side to the image side,
wherein, during focusing from infinity to the close distance, the first lens group is stationary relative to an image plane, and the focus lens group A and the focus lens group B move in an optical axis direction relative to the image plane,
wherein the focus lens group A moves in a direction including a component in a direction perpendicular to an optical axis to correct an image shake, and
wherein the following conditional inequality is satisfied:
$$0.48 \leq ( - β ) \leq 5. ,$$
where β denotes an image magnification of the optical system at a closest focus.

2. The optical system according to claim 1, wherein the following conditional inequality is satisfied:
$$\vert TSAj \vert / \vert TSAi \vert ,$$
where TSAi denotes an image shift sensitivity of the focus lens group A at infinity focus, and TSAj denotes an image shift sensitivity at a closest focus.

3. The optical system according to claim 1, wherein the following conditional inequality is satisfied:
$$1. < \vert fFB / fFA \vert < 4. ,$$
where fFA denotes a focal length of the focus lens group A, and fFB denotes a focal length of the focus lens group B.

4. The optical system according to claim 1, wherein the following conditional inequality is satisfied:
$$0.7 < \vert f 1 / fB \vert < 8. ,$$
where f1 denotes a focal length of the first lens group, and fFB denotes a focal length of the focus lens group B.

5. The optical system according to claim 1, wherein the following conditional inequality is satisfied:
$$0.2 < f / f 1 < 2.4 ,$$
where f denotes a focal length of the entire optical system, and f1 denotes a focal length of the first lens group.

6. The optical system according to claim 1, wherein a lens disposed closest to an object side in the first lens group has a positive refractive power.

7. The optical system according to claim 1, wherein the following conditional inequality is satisfied:
$$- 2. < ( R 2 + R 1 ) / ( R 2 - R 1 ) < 4.0 ,$$
where R1 denotes a radius of curvature of an object-side lens surface of a lens disposed closest to an object side in the first lens group, and R2 denotes a radius of curvature of an image-side lens surface of the lens.

8. The optical system according to claim 1, wherein the following conditional inequality is satisfied:
$$1.48 < nAave < 1.7 ,$$
where nAave denotes an average of refractive indices, for a d-line, of materials of all negative lenses included in the focus lens group A.

9. The optical system according to claim 1, wherein the following conditional inequality is satisfied:
$$0.15 < \vert mBh / mAh \vert < 0.6 ,$$
where mAh denotes an amount of movement of the focus lens group A on the optical axis during focusing from infinity to the close distance, and mBh denotes an amount of movement of the focus lens group B on the optical axis.

10. The optical system according to claim 1, wherein the focus lens group B consists of a single lens.

11. The optical system according to claim 1, wherein a lens disposed closest to the image side in the optical system is a meniscus lens having a convex surface facing the image side.

12. The optical system according to claim 1, wherein, during focusing from infinity to the close distance, the focus lens group A moves toward the image side in the optical axis direction.

13. The optical system according to claim 1,
wherein the rear group includes a focus lens group C disposed on the image side of the focus lens group A, and
wherein, during focusing from infinity to the close distance, the focus lens group C moves in the optical axis direction relative to the image plane.

14. The optical system according to claim 1,
wherein the optical system includes the first lens group, a second lens group having a positive refractive power, a third lens group having a positive refractive power, the aperture stop, a fourth lens group having a negative refractive power, and a fifth lens group having a negative refractive power disposed in this order from the object side to the image side,
wherein intervals between the lens groups in the optical axis direction change during focusing from infinity to the close distance,
wherein the fourth lens group is the focus lens group A, and
wherein the second lens group is the focus lens group B.

15. The optical system according to claim 13,
wherein the optical system includes the first lens group, a second lens group having a negative refractive power, a third lens group having a positive refractive power, the aperture stop, a fourth lens group having a negative refractive power, a fifth lens group having a positive refractive power, and a sixth lens group having a positive refractive power disposed in this order from the object side to the image side,
wherein intervals between the lens groups in the optical axis direction change during focusing from infinity to the close distance,
wherein the fourth lens group is the focus lens group A,
wherein the second lens group is the focus lens group B, and
wherein the fifth lens group is the focus lens group C.

16. The optical system according to claim 13,
wherein the optical system includes the first lens group, a second lens group having a positive refractive power, a third lens group having a positive refractive power, the aperture stop, a fourth lens group having a negative refractive power, a fifth lens group having a positive refractive power, and a sixth lens group having a positive refractive power disposed in this order from the object side to the image side,
wherein intervals between the lens groups in the optical axis direction change during focusing from infinity to the close distance,
wherein the fourth lens group is the focus lens group A,
wherein the second lens group is the focus lens group B, and
wherein the fifth lens group is the focus lens group C.

17. An imaging apparatus comprising:
an optical system; and
an imaging element configured to receive an image formed by the optical system,
wherein the optical system includes a front group including one or more lens groups, an aperture stop, and a rear group including one or more lens groups, the front group, the aperture stop, and the rear group being disposed in this order from an object side to an image side, intervals between lens groups adjacent to each other being changed during focusing,
wherein the rear group includes a focus lens group A including at least one positive lens and at least one negative lens,
wherein the focus lens group A moves toward the image side when focused from infinity to a close distance,
wherein the front group includes a first lens group having a positive refractive power and a focus lens group B disposed in this order from the object side to the image side,
wherein, during focusing from infinity to the close distance, the first lens group is stationary relative to an image plane, and the focus lens group A and the focus lens group B move in an optical axis direction relative to the image plane,
wherein the focus lens group A moves in a direction including a component in a direction perpendicular to an optical axis to correct an image shake, and
wherein the following conditional inequality is satisfied:
$$0.48 \leq ( - β ) \leq 5. ,$$
where β denotes an image magnification of the optical system at a closest focus.
